(19) United States
(12) Patent Application Publication
(10) Pub. No.: US 2011/0172175 A1
(43) Pub. Date: Jul. 14, 2011

(54) PROCESS AND COMPOSITION FOR COATING PROPAGATION MATERIAL

(75) Inventors: Victor Shui Chiu Chow, Greensboro, NC (US); Alan Nelson, Greensboro, NC (US); Jacqueline Behles, Sugar Land, TX (US)

(73) Assignee: SYNGENTA CROP PROTECTION, INC., Greensboro, NC (US)

(21) Appl. No.: 11/720,439

(22) PCT Filed: Nov. 23, 2005
(86) PCT No.: PCT/US2005/042679

§ 371 Date: Jan. 26, 2011

Related U.S. Application Data
(60) Provisional application No. 60/631,648, filed on Nov. 30, 2004.

(51) Int. Cl. A01N 43/16; B05D 3/06; B05D 3/02; A01P 7/04

(52) U.S. Cl. 514/31; 427/558; 427/517; 427/519; 514/772.3

(57) ABSTRACT

The present invention provides a process for coating a plant propagation material, including a seed, comprising: a.) providing a propagation material, such as seed, to be coated; b.) applying to the propagation material a composition comprising at least one reactant having reactive functionality and, optionally, at least one active ingredient; and c.) polymerising, crosslinking, curing or otherwise reacting the reactant having reactive functionality on the surface of the plant propagation material to form a coating thereon which may encompass an a.i., when present. The present invention further provides a method for enhancing the safety, quality and/or viability of a plant propagation material, including a seed, comprising providing a coated material having less dust-off.

### FIELD OF THE INVENTION

The field of the invention relates to polymer coated plant propagation material, to coating processes, to compositions for coating plant propagation material and to related methods of use thereof.

### BACKGROUND

Commercial farming depends upon the use of seeds that have excellent germination and high resistance to soil, air, and water borne diseases and animal pests. The benefits of treating planting seed are well known. Among these benefits are reduced, or substantially eliminated, incidences of stand loss due to diseases and animal pests such as insects and nematodes.

Seed coatings have been used as means for protecting and enhancing the viability of the natural seed coat, to control seed germination and/or improve seedling survival and growth rate. Seed coatings that contain a pesticide, fungicide, or other active ingredient and a polymer to hold the active ingredient on the seed, are commonly applied to the surface of seeds.

Some of the desirable properties of polymers used in polymeric seed coatings include: (a) adheres effectively to the seed surface while providing a smooth and uniform seed coating; (b) resists hydration at high humidity; (c) results in a flexible coating which will not be friable during bagging and planting of the seeds; (d) does not allow the generation of dust during processing of the seeds; (e) is non-flammable; (f) has some degree of glycerol or ethylene glycol solubility to permit treating seeds at sub-zero temperatures; (g) is capable of forming a relatively low viscosity solution; (h) does not generate seed aggregates during the coating process; (i) allows seed treating throughput of at least 100 bushels/hr.; (j) is permeable to both water and oxygen; (k) can be easily washed off processing equipment when deposited thereon during treating of the seeds with the seed coating formulation, or when planting the treated seeds; and, (l) allows adequate seed bulk flow properties and concomitant plantability as compared to untreated seed.

However, in some cases the utility of existing seed polymer coatings and processes leaves something to be desired when such polymer coatings are used in connection with pesticide seed treatments and/or with certain seed lots of variable quality. Accordingly, the development of seed coatings which are uniform, safe to stored seeds, that strongly adhere to seeds, that are resistant to cracking and flaking even during handling and transportation of the seeds, and which allow adequate germination, seed bulk flow properties and concomitant plantability as compared to untreated seed have provided significant technical challenges in both design and formulation. Thus, it would be desirable to develop a seed coating process and composition that has one or more of these desired properties.

### SUMMARY OF THE INVENTION

It has been found that application of a composition comprising at least one polymerizable reactant to plant propagation material, such as seed, and polymerising the reactant on the surface thereof to form a polymer coating thereon reduces the dust-off or flake-off of materials from the treated seed. The inventive process also is useful to improve one or more properties including the safety, viability, germination, storage stability, bulk flow properties and plantability of treated seed.

In one aspect, the present invention relates to a process for coating plant propagation material such as a seed that comprises (1) contacting a plant propagation material with a composition comprising at least one reactant with reactive functionality and (2) polymerizing or crosslinking at least one reactant on the surface of the plant propagation material to form a coating thereon and, optionally, treating the coated plant propagation material with at least one active ingredient (“a.i.”).

The present invention also is directed to a process for coating plant propagation material comprising contacting the plant propagation material with a composition comprising at least one reactant having reactive functionality and at least one a.i. and polymerising or crosslinking the reactant to form an a.i.-containing coating on the surface of the propagation material.

The present invention is further directed to a process for coating plant propagation material comprising contacting the plant propagation material having at least one a.i. on its surface with at least one reactant having reactive functionality and polymerizing or crosslinking the reactant to form a coating on the surface of the propagation material. In one embodiment, the coating substantially covers and/or encapsulates at least one a.i. on the propagation material surface.

Additionally, the present invention concerns a plant propagation treatment composition, including a seed treatment composition, comprising a mixture of at least one reactant having reactive functionality with at least one a.i. that is suitable for preparing an a.i.-containing coating on the plant propagation material, including a seed.

Further, the present invention relates to a method for enhancing the safety, quality and viability of plant propagation material by contacting the material with a composition comprising at least one reactant having reactive functionality and polymerizing or crosslinking the reactant on the surface of the propagation material to provide a coating on the propagation material as described herein above.

The present invention further relates to a method of controlling plant pests, which comprises applying to the plant propagation material a pesticidally effective amount of a pesticidal coating composition that is suitable for preparing or forming a pesticidal coating on the surface of the propagation material.

The present invention also relates to novel plant propagation material that has been coated in accordance with a process as described above. Unlike conventional processes of forming polymer coatings on seeds and other plant propagation materials wherein polymer solutions or dispersions are applied to the seed or material and allowed to dry and/or cure, in accordance with the present invention the coating is synthesized directly on the surface of the seed or propagation material by polymerising or crosslinking or otherwise reacting the one or more reactants having reactive functionality.

The reactants having reactive functionality suitable for use in the present invention are easy and economical to apply to the propagation materials, and the application can be done in the same equipment in which the propagation materials are treated with active ingredients. The reactants are selected to prepare polymerized, crosslinked, or otherwise reacted coatings that comprise, for example, acrylates or acrylate oligomers, urea-formaldehydes (such as aminoplasts), and polyfunctional amines. The coating formed by the process of the present invention is a continuous or semi-continuous covering of the seed, which effectively traps the active ingredient(s) onto the surface of the seed and prevents dust-off of the active ingredient(s). The coating is a polymer matrix that may be highly or lowly physically and/or chemically crosslinked, and the density of the crosslinking can influence the degree of release properties of the active ingredient(s). The resulting coating is semi-permeable or permeable to water to initiate the growth process of the plant propagation material and release of the active ingredient(s).

Among the several advantages found to be achieved by the present invention, there may be noted an increase in safety and shelf-life of treated plant propagation material, a reduction in the phytotoxicity of active ingredients used in treatment of plant propagation materials, a reduction in the rate of loss of the a.i. during storage, reduced dust-off /flake-off of the treated material, and improved worker safety.

### DETAILED DESCRIPTION OF THE INVENTION

The term “plant propagation material” is used herein to refer to all the generative parts of the plant that can be used for the multiplication of the vegetative plant material such as cuttings and tubers (for example potatoes). There may be mentioned, for example and not for limitation, the seeds (in the strict sense), roots, fruits, tubers, bulbs, rhizomes, and parts of plants. Germinated plants and young plants, which are to be transplanted after germination or after emergence from the soil, may also be mentioned. These young plants may be coated before transplantation by a total or partial treatment by immersion or the like. In a specific embodiment, the method of the present invention has particular application for coating the plant propagation material of cultivated plants. Such plants are those plants that are cultivated by man, or from which is harvested parts or products that are used by man. Suitable cultivated plant propagation material includes, but is not limited to, seed selected from monocotyledonous, dicotyledonous, and multicotyledonous (gymnosperm) plants.

The term “aqueous” is understood to denote water or, optionally, a water-based solvent system comprising a mixture of water and a water-miscible organic solvent such as a solvent selected from the ketones, esters, ethers, cyclic amides or sulfoxides. Particular examples of these solvents include, but are not limited to, acetone, ethyl alcohol, methyl alcohol, isopropyl alcohol, dimethylformamide, methyl-ethyl ketone, butyl lactate and the like. A mixture of water with two or more water-miscible organic solvents such as those cited above may be used. In one embodiment, a water-based solvent system comprises a mixture of a major amount of water with a minor amount of such a water-miscible organic solvent or solvent mixture.

The reactants having reactive functionality include monomers and polymers and any reagent capable of forming a coating having network-forming or crosslinkable characteristics. The reactants suitable for use in the present invention are easy and economical to apply to the plant propagation materials, and the application can be done in the same equipment, prior to, after, or at the same time as, when the materials are treated with active ingredients. The reactants having reactive functionality are selected to prepare polymer or polymer-like coatings that comprise, for example, acrylates or acrylate oligomers, urea-formaldehydes (such as aminoplasts), and polyfunctional amines. In one embodiment, the polymerizable reactant is substantially free of crosslinkable silicone materials.

The coating is a continuous or semi-continuous covering of the seed, which effectively traps the active ingredient(s) onto the surface of the seed and prevents dust-off of the active ingredient(s). The coating is a polymer matrix that may be highly or lowly physically and/or chemically crosslinked, and the density of the crosslinking can influence the degree of release properties of the active ingredient(s). The polymer coating is semi-permeable or permeable to water to initiate the growth process of the seed and release of the active ingredient(s).

For example, and not for limitation, suitable reactants having reactive functionality may be selected from polyamines, polyalcohols, ethylenically unsaturated monomers, epoxy-functionalized monomers, urea-formaldehydes, melamine-formaldehydes, benzoguanamine-formaldehydes and glycoluril-formaldehydes. As noted above, in one embodiment, the reactant having reactive functionality is substantially free of crosslinkable silicone materials.

Accordingly, the present invention provides a process for coating a plant propagation material, including a seed, comprising:

a.) providing a propagation material, such as seed, to be coated;

b.) applying to the propagation material a composition comprising at least one reactant having reactive functionality and, optionally, at least one active ingredient; and

c.) polymerising, crosslinking, curing or otherwise reacting the reactant having reactive functionality on the surface of the plant propagation material to form a coating thereon which may encompass an a.i., when present. More specifically, a networked, crosslinked, or matrix coating forms on the surface of a propagation material such as a seed by the reaction between at least two reactants having reactive functionality, wherein the molar ratio between the reactive functional groups of the reactants is substantially equivalent. Alternatively, a networked, crosslinked, or matrix coating forms on the surface of a propagation material such as a seed by the reaction of at least one reactant having reactive functionality and a photoinitiator and curing the composition under ultraviolet conditions.

The present invention includes several embodiments of the process for coating plant propagation material as defined above. One general embodiment of the present invention includes a process for coating a plant propagation material, including a seed, comprising contacting the propagation material with a composition comprising at least one reactant having reactive functionality, a photoinitiator, and optionally an a.i., and effecting reaction by curing the composition under ultraviolet conditions. Included within this general process is reaction between the reactant having reactive functionality, a photoinitiator and an a.i. that is protected against uv-radiation. The uv-protection of the a.i. may be in any form known in the art and includes, but is not limited to, encapsulation of the a.i. and combination of the a.i. with fillers that mask exposure of the a.i. from uv-radiation. Also included within this general process is reaction between the reactant having reactive functionality, a photoinitiator, a co-initiator, and optionally an a.i., which may be unprotected or protected as described above.

A second general embodiment of the present invention includes a process for coating a plant propagation material, including a seed, comprising contacting the propagation material with at least one polyfunctional amine and at least one reactant having polyfunctional ethylenically unsaturated functionality, and optionally an a.i., and effecting reaction on the surface of the plant propagation material such that a networked, crosslinked, or matrix coating forms thereon. Included within this general process are processes wherein at least one diamine reactant is subjected to a Michael addition reaction with at least one polyfunctional ethylenically unsaturated monomer reactant. Also included within this general process are processes wherein either the at least one polyfunctional amine reactant or the at least one reactant having polyfunctional ethylenically unsaturated functionality is first combined with an a.i. prior to combining on the surface of the plant propagation material. Further included within this general class of processes is a process wherein at least one polyfunctional amine reactant or the at least one reactant having polyfunctional ethylenically unsaturated functionality is first combined with a protected a.i. prior to combining on the surface of the plant propagation material. In this process, the a.i. may optionally be protected to prevent degradation due to changes in pH. Such protection of the a.i. may be achieved by any means known in the art, including but not limited to polymeric micro encapsulation, adsorption on fillers, and micelle formation.

A third general embodiment of the present invention includes a process for coating a plant propagation material, including a seed, comprising contacting the propagation material with an aminoplast composition formed by reacting an amino resin pre-polymer in an aqueous acid-catalyzed phase on the surface of the plant propagation material to form a polymer network or polymer matrix thereon. Included within this general process for coating plant propagation material is a process wherein the reaction of an amino resin pre-polymer in an aqueous acid-catalyzed phase occurs at room temperature or at elevated temperature. Also included within this general process for coating plant propagation material is a process wherein the amino resin pre-polymer may be combined with an a.i. prior to reacting with the aqueous acid-catalyzed phase to form a polymer network or polymer matrix. Further included within this general process for coating plant propagation material is a process wherein the aqueous acid-catalyzed phase may be combined with an a.i. prior to reacting with the amino resin pre-polymer to form a polymer network or polymer matrix.

In each of the above-identified general embodiments of the present invention, a reagent may optionally include an active ingredient for treatment of the plant propagation material. For example, and not for limitation, a suitable amount of a first reactant is added to a plant propagation material treatment formulation (such as a pesticidal seed treatment) and homogeneously mixed to form a slurry. This slurry is sprayed onto the seeds at recommended rates at ambient temperature. A reaction mixture is formed on the surface of the plant propagation material by simultaneously or sequentially applying to the plant propagation material (a) ultraviolet radiation at a wavelength suitable to effect curing of the reagent or (b) at least one additional reactant having reactive functionality under conditions suitable to cause reaction of the first and additional reactants, thereby forming a polymer-type coating on the surface of the plant propagation material. In general, the components are selected such that the reaction is completed in a matter of seconds and the resulting coating or matrix surrounds each individual treated seed or other plant propagation material.

In another embodiment, a coating in accordance with the present invention is prepared on seed or other propagation material that has been previously coated or covered with a slurry composition of pesticide or other active ingredients. By coating the pretreated seed or propagation material, the present invention provides a method of improving the dust-off property of a propagation material, including seeds, by coating or encapsulating a plant propagation material with a polymeric wall or matrix in accordance with the present invention.

In another aspect of the invention, seed or other propagation material is provided with a coating prepared in accordance with the present invention before further treating the seed with any pesticide or other active ingredient. This technique has particular application for improving the quality of seed lots which otherwise would have reduced germination or viability (below a commercial standard (e.g. <70%)), which germination or viability reduction is occasioned by the phytotoxicity of seed treatment pesticides or other active ingredients. Although not wishing to be bound by theory, it is believed that the provision of a coating in accordance with the present invention prior to application of a seed treatment active ingredient will cover or block minute cracks in the seed pericarp and thereby reduce penetration of the pesticide or other phytotoxic active into the seed embryo.

In yet another aspect of the invention, seed or other propagation material is provided with multiple alternate layers of a coating prepared in accordance with the present invention. For example, multiple layers are provided on a seed with configurations such as pericarp-pesticide-(coating-pesticide-coating)ₙ or pericarp-coating-(pesticide-coating-pesticide)ₙ, wherein the variable n is a number from 1 to 10; or n is a number from 1 to 5; or is n is a number from 1 to 3; or n is the number 1. Multiple layers can be employed, for example, so that the release of pesticides can be controlled or released at different rates. For example and not for limitation, one pesticide may be released over a period of minutes, another over a period of hours, and yet another over a period of days or weeks, as the case may be. In addition, pesticides having a higher relative phytotoxicity to the seed being treated may be separated from the pericarp by a coating layer, whereas others can be applied directly to the pericarp. In each instance of applying a coating, one or more of the processes of the present invention may be employed. For example, and not for limitation, one coating may be prepared using an ultraviolet curing process as described herein, while another coating applied to the same plant propagation material may be prepared using the Michael addition reaction between polyfunctional amines and reactants having polyfunctional ethylenically unsaturated functionality described herein. Still another layer of coating may be prepared and applied by forming aminoplasts on the surface of the plant propagation material as described herein. Each coating layer is independently formed from any of the processes described herein or by any other coating process known in the art.

Optimum configurations for particular seeds, coatings, pesticides and target pest pressure conditions can be determined easily and without undue experimentation by simple ranging studies carried out in greenhouse or field settings. In particular, the type of coating and the coating thickness are designed and selected to provide desired properties such as improved seed safety, shelf-life, viability (oxygen transfer), germination (moisture transfer), phytotoxicity and dust-off.

UV-Curable Coatings/Reactive Diluent

In one embodiment of the present invention, a seed coating may be prepared by the use of monomer or oligomer containing a monoethylenically and/or polyethylenically unsaturated functionality and/or an epoxy-functionalized monomer or oligomer containing one or more epoxy groups available for reaction. A photoinitiator is combined with the monomer and/or oligomer to effect reaction of the reagents upon exposure of the reactants to uv-radiation. The composition containing the monomer and/or oligomer and photoinitiator is deposited on the plant propagation material and exposed to uv-radiation,

Vinyl ether compounds which are suitable for use in the present invention include vinyl ether monomer and oligomers which are generally known in the art and may be described as: (R′CH═CR″—OZ)ₙ-A where R′ and R″ may be the same or different and are independently selected from H or an alkyl group having 1 to 10 carbon atoms; A is a moiety derived from urethanes, phenols, polyesters, polyethers, polycarbonates, or polysiloxanes and has a molecular weight of about 400 to 10,000; Z is a moiety derived from a saturated aliphatic or cycloaliphatic hydrocarbon or a polyalkylene ether and has a molecular weight of about 28 to 250; n is an integer from 2 to 6, preferably 2 or more.

Examples of preferable vinyl ether monomers and oligomers used in the present invention are 1-butanol-4-(ethenyloxy)-benzoate, pentanedioic acid bis[[4-[(ethenyloxy)methyl]ester, butanedioic acid bis[4-(ethynyloxy)butyl]ester, carbamic acid (methylene di-4,1-phenylene)bis-bis[4-(ethynyloxy)butyl]ester, carbamic acid (methyl-1,3-phenylene)bis-, bis[4-(ethynyloxy)butyl]ester, mixtures thereof and the like. The vinyl ether compounds may be present in amounts up to about 100 weight %, preferably from about 5 to about 100 weight % and in some embodiments more preferably between about 20 to about 100 weight %. In addition, the mono-, di- and trifunctional vinyl ether monomers are used for diluency, as generally known in the art.

Suitable acrylates include acrylate oligomers. Examples of acrylate oligomers include acrylated aliphatic urethane oligomers such as ethoxylated bisphenol A di(meth)acrylate, divinylbenzene, vinyl(meth)acrylate, allyl(meth)acrylate, diallyl maleate, diallyl fumarate, methylene bisacrylamide, cyclopentadienyl acrylate, triallyl cyanurate, and poly(ethylene glycol)di(meth)acrylate, alkylene glycol diacrylates and dimethacrylates selected from the group consisting of ethylene glycol di(meth)acrylate, diethylene glycol di(meth)acrylate, 1,3-butylene glycol di(meth)acrylate, 1,4-butylene glycol di(meth)acrylate, neopentyl glycol di(meth)acrylate, and propylene glycol di(meth)acrylate. In general, urethane(meth)acrylates may include aromatic or aliphatic urethane(meth)acrylates including those wherein the polyol used to make the urethane is a polyether or a polyester.

Ebecryl 8804 (UCB Chemical), and ethoxylated bisphenol A diacrylate, SR 349, (Sartomer), mixtures thereof and the like are among preferred acrylates used in the present invention. Coatings containing vinyl ether/acrylate exhibit excellent abrasion resistance, flexibility and high modulus when cured. (Sitzmann et. al., RadTech98 Conf. Proc. (1998)). The acrylates may be present in amounts up to about 100 weight %, preferably from about 10 to about 100 weight % and in some embodiments more preferably between about 50 to about 90 weight %.

The UV-curable coating compositions may optionally contain one aliphatic urethane (meth)acrylate prepolymer polyurethane (PU) having at least two double bonds per molecule, or a mixture of such prepolymers PU with at least one reactive diluent, selected preferably from difunctional and polyfunctional esters of acrylic acid and/or of methacrylic acid with aliphatic diols or polyols.

Aliphatic urethane (meth)acrylate prepolymers are polymeric or oligomeric compounds that have urethane groups and acryloxyalkyl and/or methacryloxyalkyl groups or (meth)acrylamidoalkyl groups. Normally, the (meth)acryloxyalkyl and/or (meth)acrylamidoalkyl groups are attached via the oxygen atom of the urethane group. The term acryloxyalkyl groups refers to C₁-C₁₀ alkyl radicals, preferably C₂-C₅ alkyl radicals, substituted by one, two or three, preferably one, acryloxy group. Similar comments apply to methacryloxyalkyl groups. Accordingly, (meth)acrylamidoalkyl groups are C₁-C₁₀ alkyl radicals, preferably C₂-C₅ alkyl radicals, substituted by one, two or three (meth)acrylamido groups, preferably by one (meth)acrylamido group. In accordance with the invention, the aliphatic urethane(meth)acrylate prepolymers PU have at least two double bonds per molecule, preferably from three to six double bonds per molecule. The aliphatic urethane(meth)acrylate prepolymers PU of the invention are essentially free from aromatic structural elements, such as phenylene or naphthylene or substituted phenylene or naphthylene groups.

The urethane(meth)acrylate prepolymers or oligomers PU used as binders normally have a number-average molecular weight Mₙ in the range from 500 to 5000, preferably in the range from 500 to 2000 daltons (as determined by means of GPC on the basis of authentic comparison samples). The double bond equivalent weight (g of polymer per double bond present therein) is preferably in the range from 250 to 2000 and in particular in the range from 300 to 900.

The prepolymers PU preferably have a viscosity in the range from 250 to 11,000 mPa·s, in particular in the range from 1000 to 8000 mPa·s.

Photochemically crosslinkable formulations may also contain or may additionally contain epoxy-functional monomers, such as glycidal methacrylate. Epoxies, when combined with vinyl ethers, are most useful for the present invention when they display as many of the following properties as possible. Epoxies should have a functionality of at least two, i.e., they should have at least two oxirane moieties for each molecule, provide a low viscosity to the formulation, and be completely miscible with the other components.

Epoxies derived from phenols, particularly bisphenol A, novolacs, linear and cycloaliphatic polyols, polyether polyols and siloxanes are preferred. Examples of epoxies that are most preferable in the present invention are bisphenol A diglycidyl ethers (such as DER 331, 332, Dow Chemical and Epon 828, Shell Chemical), glycidyl(meth)acrylate, epoxy(meth)acrylate, epoxy novolacs (such as DEN 431, Quatrex 240, Dow Chemical), epoxy cresols (such as Quatrex 3310, Dow Chemical), and cycloaliphatic epoxides (such as ERL 4221, ERL 4299, ERL 4234, Union Carbide). The epoxies, when present, may be present in amounts up to about 80 weight %, preferably from about 10 to about 80 weight % and in some embodiments more preferably between about 10 to about 50 weight %.

Photo initiators are employed in an amount from 0.001 up to 15% and preferably from 1 to 10% by weight, based on the solids content of the coating composition. Examples include benzophenone and benzophenone derivatives, such as 4-phenylbenzophenone and 4-chlorobenzophenone, Michler's ketone, acetophenone derivatives, such as 1-benzoylcyclohexan-1-ol, 2-hydroxy-2,2-dimethylacetophenone, and 2,2-dimethoxy-2-phenylacetophenone, benzoin and benzoin ethers, such as methyl, ethyl and butylbenzoin ethers, benzyl ketals, such as benzyl dimethyl ketal, 2-methyl-1-[4-(methylthio)phenyl]-2-morpholinopropan-1-one, anthraquinone and its derivatives, such as methylanthraquinone and tert-butylanthraquinone, acylphosphine oxides, such as 2,4,6-trimethylbenzoyldiphenylphosphine oxide, ethyl 2,4,6-trimethylbenzoylphenylphosphinate, methyl 2,4,6-trimethylbenzoylphenylphosphinate and bisacylphosphine oxides.

The uv-curable formulations of the present invention are subjected to uv-radiation at a range between 190 and 400 nanometers.

The UV-curable formulations of the invention may optionally contain up to 35% by weight of customary auxiliaries, such as thickeners, levelling assistants, defoamers, UV stabilizers, lubricants, and fillers. Suitable auxiliaries are sufficiently well known to the skilled worker from the technology of paints and coatings. Appropriate fillers comprise silicates, e.g., silicates obtainable by hydrolysis of silicon tetrachloride, such as Aerosil™ from Degussa, siliceous earth, talc, aluminium silicates, magnesium silicates, calcium carbonates, etc. Suitable stabilizers include typical UV absorbers, such as oxanilides, triazines and benzotriazole and benzophenones. These may be used alone or together with appropriate free-radical scavengers, with examples of such are sterically hindered amines, including 2,2,6,6-tetramethylpiperidine, 2,6-di-tert-butylpiperidine or derivatives thereof, e.g., bis(2,2,6,6-tetramethyl-4-piperidyl)sebacate. Stabilizers are used commonly in amounts of from 0.01 to 5.0% by weight and preferably from 0.1 to 3.0% by weight, based on the coating composition.

Michael Addition with Diacrylates and Diamines

In another embodiment of the present invention, seeds or other plant propagation material may be coated through the use of a Michael reaction, forming a crosslinked polymer network that coats the material. In this embodiment, a polyfunctional amine reacts with a polyfunctional ethylenically unsaturated bond to form a crosslinked network on the surface of the seeds. Either of these materials may independently be added neat, aqueous, or by using a suitable organic solvent such as acetone, methanol, chloroform, tetrahydrofuran, each of which has a low vapor pressure and will be able to wet the materials rather than soak the plant propagation materials.

Suitable poly-amines include compounds having primary and/or secondary amino groups (as these terms are conventionally understood by one of ordinary skill in the art) of 2 to 10 amino groups per molecule, such as primary amines, and specific examples of which include, but are not limited to ethylenediamine, propylenediamine, trimethylene diamine, tetramethylene diamine, pentamethylene diamine, hexamethylene diamine, 4-(aminomethyl)-1,8-octanediamine, decamethylene diamine, 1,2-diaminocyclohexane, isophoronediamine, tris(2-aminoethyl)amine, diethylenetriamine, dipropylenetriamine and dibutylenetriamine, triethylene tetramine, triaminopropane, 2,2,4-trimethylhexamethylene diamine, tolylene diamine, hydrazine, piperadine, piperazine, cycloaliphatic polyamines such as isophorone diamine and dicyclohexylmethane-4,4′-diamine, as well as aromatic polyamines such as phenylene diamine and xylylene diamine.

Suitable polyethylenically unsaturated monomers include but are not limited to alkylene glycol diacrylates and dimethacrylates, such as ethylene glycol di(meth)acrylate, diethylene glycol di(meth)acrylate, 1,3-butylene glycol di(meth)acrylate, 1,4-butylene glycol di(meth)acrylate, neopentyl glycol di(meth)acrylate, ethoxylated bisphenol A di(meth)acrylate, and propylene glycol di(meth)acrylate. Also suitable are divinylbenzene, vinyl(meth)acrylate, allyl(meth)acrylate, diallyl maleate, diallyl fumarate, methylenebisacrylamide, cyclopentadienyl acrylate, and triallyl cyanurate. Additional monomers that are suitable are those such as any range of molecular weight of poly(ethylene glycol)di(meth)acrylate, as well as any other polyfunctional ethylenically unsaturated polymer, including varying polymer structures such as random, block, brush, and graft copolymers. The entirety of the polymer may not comprise a reactive functionality and rather may be comprised of materials such as monomers including styrene, vinyl toluene, ethylene, vinyl acetate, vinyl chloride, vinylidene chloride, acrylonitrile, (meth)acrylamide, various (C₁-C₂₀)alkyl or (C₃-C₂ₒ)alkenyl esters of (meth)acrylic acid (the expression of (meth)acrylic acid is to serve as indication of both acrylic acid and methacrylic acid), such as methyl acrylate, methyl methacrylate, butyl(meth)acrylate, stearyl acrylate.

The process of the present invention may include independently providing a polyamine which is neat or in aqueous form with a solvent. When provided in aqueous form, the solvent may be an organic solvent. Suitable organic solvents include, but are not limited to acetone, methanol, chloroform, ethanol, and tetrahydrofuran.

The process of the present invention may include independently providing a polyfunctional ethylenically unsaturated monomer which is neat or in aqueous form with a solvent. When provided in aqueous form, the solvent may be an organic solvent. Suitable organic solvents include, but are not limited to acetone, methanol, chloroform, ethanol, tetrahydrofuran, and aqueous methylene bisacrylamide.

The formulations employed in this embodiment of the invention may optionally contain up to 35% by weight of customary auxiliaries, such as thickeners, levelling assistants, defoamers, UV stabilizers, lubricants, and fillers. Suitable auxiliaries are sufficiently well known to the skilled worker from the technology of paints and coatings. Appropriate fillers comprise silicates, e.g., silicates obtainable by hydrolysis of silicon tetrachloride, such as Aerosil™ from Degussa, siliceous earth, talc, aluminium silicates, magnesium silicates, calcium carbonates, etc. Suitable stabilizers include typical UV absorbers, such as oxanilides, triazines and benzotriazole and benzophenones. These may be used alone or together with appropriate free-radical scavengers, with examples of such are sterically hindered amines, including 2,2,6,6-tetramethylpiperidine, 2,6-di-tert-butylpiperidine or derivatives thereof, e.g., bis(2,2,6,6-tetramethyl-4-piperidyl)sebacate. Stabilizers are used commonly in amounts of from 0.01 to 5.0% by weight and preferably from 0.1 to 3.0% by weight, based on the coating composition.

### Polyvalent Metal Ions

In another embodiment, a coating comprising an polymeric complex is formed from a polyelectrolyte selected from an acid copolymer which is neutralized with polyvalent metal ions, such as those selected from groups Ia, Ib, IIa, IIb, IIIa, of the Periodic Table of Elements such as zinc, calcium, magnesium, and aluminum. Suitable adhesion is achieved with acid copolymers neutralized with ions such as zinc, calcium or magnesium, most specifically zinc. Such ionized acid copolymers are known in the art as “ionomers”. Typically, crosslinking will be from 5-95%. In one embodiment the copolymer has from about 35 to 70% of the carboxylic acid groups ionized by ion exchange with metal counterions.

### Aminoplasts

In an additional embodiment of the present invention, plant propagation material may be coated using a reaction wherein an aminoplast type coating is formed. This coating is comprised from one or more amino resin prepolymer reacting with an acidic aqueous phase containing a catalyst.

Suitable amino resin prepolymers include formaldehydes of the general classes including urea-formaldehyde, melamine-formaldehyde, benzoguanamine-formaldehyde and glycoluril-formaldehyde. The first two general classes are preferred for this invention, with the urea-formaldehyde being the most preferred. Suitable urea-formaldehydes include, but are not limited to Cymel U-80 and Cymel U-1050-10, both from Cytec Industries, Inc.

Depending on the degree of etherification (butylation) of the prepolymer an additional cross-linker may be employed in the reaction. Suitable crosslinking agents include, but are not limited to polyfunctional mercapatan esters including but not limited to pentaerythritol tetrakis(3-mercapto propionate), pentaerythritol tetrakis(3-laurylthiopropionate); esters including but not limited to glycerol-3-stearyl thiopropionate, triethylene glycol-bis[3-(3-t-butyl-5-methyl-4-hydroxyphenyl)propionate], 1,6-hexanediol-bis[3-(3,5-di-t-butyl-4-hydroxyphenyl)propionate], pentaerythritol-tetrakis[3-(3,5-di-t-butyl-4-hydroxyphenyl)propionate], octadecyl-3-(3,5-di-t-butyl-4-hydroxyphenyl)propionate, 1,3,5-trimethyl-2,4,6-tris(3,5-di-t-butyl-4-hydroxybenzyl)benzene, N,N-hexamethylenebis(3,5-di-t-butyl-4-hydroxy-hydrocinnamide), diethyl 3,5-di-t-butyl-4-hydroxy-benzylphosphonate ester, tris(3,5-di-t-butyl-4-hydroxybenzyl)isocyanurate, tetrakis(2,4-di-t-butylphenyl)-4,4′-biphenylene diphosphonate, 3,9-bis{1,1-dimethyl-2-[.beta.-(3-t-butyl-4-hydroxy-5-methylphenyl)propion yloxy]ethyl}-2,4,8,10-tetraoxaspiro(5,5)undecane and the like. The preferred class of cross-linker in this invention is polyfunctional mercapatan esters and the most preferred crosslinking agent is pentaerythritol tetrakis(3-mercaptoproprionate).

The reaction between the amino resin prepolymer and the acidic aqueous phase takes place in the presence of a catalyst. Suitable catalysts used in the present invention include any acid strong enough to protonate the reaction. Suitable catalysts include carboxylic acids, sulphonic acids, and salts thereof. A preferred catalyst for the process of the present invention is a dispersant of the sodium dialkylnapthalenesulfonate type.

### Target Crops

Virtually any propagation material, including seed, can be treated with the seed coating composition of the invention, such as cereals, vegetables, ornamentals, and fruits. In one embodiment, the seed that may be coated in accordance with the process of the invention includes, for example, seed of the following plant species: beet (sugar beet and fodder beet), oil plants (canola, rape, mustard seed, poppy, olives, sunflowers, coconut, castor oil plants, cocoa beans, groundnuts and soya). There also may be mentioned peanuts, wheat sorghum, cotton, corn, soybeans, tobacco, tomatoes, cole, cabbages, onions and carrots.

The seed of other suitable plant species within the scope of the invention include potato, mint, grass forage and hay as well as the herb subgroup.

In addition, the crops listed in the crop group tables in the United States Code of Federal Regulations, specifically 40 CFR Sec. 180.41 (1995) are noted. 40 CFR Sec. 180.41 (1995) and the Federal Register: May 17, 1995 (vol. 60, no. 95) pp. 26625-26643 are fully incorporated by reference herein for their disclosure relating to useful crop plants:

(1) Crop Group 5: Brassica (Cole) Leafy Vegetables Group, for example, broccoli, cauliflower; cabbage; and mustard greens;
(2) Crop Group 9: Cucurbit Vegetables Group, for example, cucumber, melons, cantaloupe, muskmelon, squash incl. summer squash;
(3) Crop Group 11: Pome Fruits Group, for example, apple and pear;
(4) Crop Group 15: Cereal Grains Group, for example, corn and rice.

There also may be mentioned the fruiting vegetables group, for example, tomatoes and peppers, as well as ornamentals and florals.

The target crops and the seeds treated in accordance with the invention include conventional as well as genetically enhanced or engineered varieties such as, for example, insect resistant (e.g., Bt. And VIP varieties) as well as disease resistant, herbicide tolerant and nematode tolerant varieties.

### Active Ingredients

Optionally, at least one active ingredient is combined with the reactant having reactive functionality prior to application of the reactive composition onto the seed. As used herein, “active ingredient” or “a.i.” means any chemical substance, whether naturally or synthetically derived, which (a) has biological activity or is capable of releasing in a plant or in the locus of the plant such as the seed growing soil environment, an ion, moiety, metabolite or derivative which has biological activity or is capable of inducing a plant to express a biological trait including, but not limited to, resistance to a herbicide or a microorganism or animal pest attack, and (b) is applied to a plant with the intent or result that the chemical substance or its biologically active ion, moiety, metabolite or derivative enter living cells or tissues of the plant or reside in the locus of the plant and elicit a stimulatory, inhibitory, regulatory, therapeutic, toxic or lethal response in the plant itself or in a pathogen, parasite or feeding organism present in or on the plant or in the locus of the plant. Examples of active ingredient substances include, but are not limited to, chemical pesticides (such as herbicides, algaecides, fungicides, bactericides, viricides, insecticides, aphicides, miticides, nematicides, molluscicides, and the like), plant growth regulators, herbicide safeners, fertilizers and nutrients, gametocides, defoliants, desiccants, mixtures thereof, and the like.

The active ingredient may be selected so as to optimize the application or the bioperformance of the seed coating composition. The form of the active ingredient composition may be selected, depending on these intended aims and the prevailing circumstances, from emulsifiable concentrates, suspension concentrates, directly sprayable or dilutable solutions, spreadable pastes, dilute emulsions, sprayable powders, soluble powders, dispersible powders, wettable powders, dusts, granules or encapsulations.

Examples of pesticides include those selected from, for example and not for limitation, insecticides, acaricides, bactericides, fungicides, nematicides and molluscicides. Active ingredients useful for these applications include, but are not limited to abamectin, acephate, acetamiprid, aldacarb, alpha-cypermethrin, azinphos-methyl, bifenthrin, carbaryl, carbofuran, carbosulfan, chlorpyrifos, clothianidin, cyromazine, deltamethrin, dimethoate, emamectin benzoate, endosulfan, fipronil, furathiocarb, gamma-HCH, imidacloprid, Isofenphos, methiocarb, omethoate, tefluthrin, thiamethoxam, thiacloprid, thiodicarb, azoxystrobin, pyraclostrobin, benomyl, bitertanol, captan, carbendazim, carboxin, chlorothalonil, copper salts (such as copper sulfate, cuprous oxide, Bordeaux mixture, copper hydroxide, copper sulfate (tribasic), copper oxychloride and copper octanoate), cymoxanil, cyproconazole, cyprodinil, difenoconazole, diniconazole, ethirimol, famoxadone, fenamidone, fenhexamid, fenpiclonil, fluazinam, fludioxonil, fluquinconazole, flutolanil, flutriafol, fosetyl-aluminium, fuberidazole, guazatine, hexaconazole, hymexazol, imazalil, iprodione, isofenphos, mancozeb, maneb, metalaxyl, metalaxyl-M, metconazole, myclobutanil, silthiofam, nuarimol, oxadixyl, oxine-copper, oxolinic acid, pencycuron, prochloraz, procymidone, pyrimethanil, pyroquilon, quintozene, tebuconazole, tetraconazole, thiabendazole, thiophanate-methyl, thiram, triadimenol, triazoxide, triticonazole, trifloxystrobin, picoxystrobin and ipconazole.

Suitable additions of insecticidally and acaricidally active ingredients are, for example and not for limitation, representatives of the following classes of active ingredients: organophosphorus compounds, nitrophenols and derivatives, formamidines, triazine derivatives, nitroenamine derivatives, nitro- and cyanoguanidine derivatives, ureas, benzoylureas, carbamates, pyrethroids, chlorinated hydrocarbons and Bacillus thuringiensis products. Especially preferred components in mixtures are abamectin, NI-25 (cyanoimine acetamiprid), TI-304 (nitromethylene nitenpyram), TI-435 (clothiamidin), MTI-446 (dinotefuran), fipronil, lufenuron, pyripfoxyfen, thiacloprid, fluxofenime; imidacloprid, thiamethoxam, fenoxycarb, diafenthiuron, pymetrozine, diazinon, disulphoton; profenofos, furathiocarb, cyromazin, cypermethrin, tau-fluvalinate, tefluthrin or Bacillus thuringiensis products, very especially abamectin, NI-25, TI-304, TI-435, MTI-446, fipronil, thiacloprid, imidacloprid, thiamethoxam and tefluthrin.

Examples of suitable additions of fungicidally active ingredients include, but are not limited to, the following compounds: azoxystrobin; bitertanol; carboxin; Cu₂O; cymoxanil; cyproconazole; cyprodinil; dichlofluamid; difenoconazole; diniconazole; epoxiconazole; fenpiclonil; fludioxonil; fluquiconazole; flusilazole; flutriafol; furalaxyl; guazatin; hexaconazole; hymexazol; imazalil; imibenconazole; ipconazole; kresoxim-methyl; mancozeb; metalaxyl; R-metalaxyl; metconazole; oxadixyl, pefurazoate; penconazole; pencycuron; prochloraz; propiconazole; pyroquilone; SSF-109; spiroxamin; tebuconazole; teflutrin; thiabendazole; tolifluamide; triazoxide; triadimefon; triadimenol; triflumizole; triticonazole and uniconazole

When the polymer coatings of the invention include a fungicide they may be useful for the reductive, preventive and the curative protection of the plant propagation material against fungi and fungal diseases including against fungi, in particular of the oomycetes which belong to the class of phycomycetes (e.g., Phytopizthora spp., Peronospora spp., Pseudoperonospora spp., Pythium spp. [i.e. P. utimum, P. aphanidernzatum, P. graminicola, P. irregulare) or Plasmopara sp.), basidiomycete (i.e. Puccinia spp. [P. recondita, P. striformis, and P. graminis], Tilletia spp. [i.e T. caries and T. contreversa], Ustilago spp. [i.e. U. maydis, U. nuda, U. hordei, and U. avenae]), ascomycete (such as Gibberella spp. [i.e. G. fujikuroi, G. roseum] Glomerella spp. [i.e. G. gossypii]), adelomycete or Fungi Imperfecti type, such as Rhizoctonia spp. (i.e. R. solani, R. cerealis and R. zea), Fusarium spp. (i.e. F. solani, F. oxysporum, F. roseum, F. nivale, F. nzoniliforme, F. proliferatum, F. graminearum, F. subglutinans), Helminthosporium spp. (i.e. H. oryzae, H. teres, H. gramineum and H. sativum), Phoma spp. (i.e. P. betae, P. foveata and P. lingam), Alternaria spp. (i.e. A. solani, A. macrospora and A. alternata), Colletotriuchum (i.e. C. graminicola, C. coccodes, C. capsici, C. gossypii and C. truncatunz), Erysiphe spp. (i.e. E. graminis and E. cichoracearum) Gaeumannomyces spp. (i.e. G. graminis var graminis and G. graminis var. tritici), Botrytis spp. (i.e. B. cinerea), Pyricularia spp. (i.e. P. grisea and P. otyzae), Cercosoora spp. (i.e. C. beticola), Rhinchosporium spp. (i.e. R. secalis), Pyrenophora spp. (i.e. P. avenae), Septoria spp. (i.e. S. tritici and S. avenae), Whetzelinia spp. (i.e. W. sclerotiorum), Microdochium spp., Mycosohaerella spp., (i.e. M. fijiensis), Aspergillus spp. (i.e. A. niger and A. flavus), Cercospora spp. (i.e. C. arachidicola and C. gossypina), Claviceps spp., Cladosporium spp. (i.e. C. herbarum), Penicillium spp., Pestalozzia sp, Verticillium spp. (i.e. V. dahliae), Ascochyta spp. (i.e. A. pisi and A. gossypii), Guignardia spp. (i.e. G. bidwellii), Corticiunz rolfsii, Phomposis spp. (i.e. P. viticola), Sclerotinia spp. (i.e. S. sclerotiorum and S. minor), Sclerotinia minor, Coryneum cardinale, Acrostalagmus koningi, Corticium Diplodia spp. (i.e. D. natalensis), Hormodendron cladosporioides, Myrothecium spp. (i.e. M. verrucaria), Paecylomyces varioti, Pellicularia sasakii, Phellinus megaloporus, Septoria spp., Sclerotium spp. (i.e. S. rolfsii), Stachybotris atra, Trichoderma ssp. (i.e. T. pseudokoningi), Thielaviopsis basicola and Trichothecium roseum.

Polymer coatings according to the invention having an insecticide may be used for the protection of the plant propagation material and developing plants against animal pests such as insects and representatives of the order Acarnia including:

from the order Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, Chilo spp., Choristoneura spp., Clysia ambiguella, Cnaphalocrocis spp., Cnephasia spp., Cochylis spp., Coleophora spp., Crocidolomia binotalis, Ctyptophlebia leucotreta, Cydia spp., Diatraea spp., Diparopsis castanea, Earias spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiella, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; from the order Coleoptera, for example, Agriotes spp., Anthonomus spp., Atomaria linearis, Chaetocnema tibialis, Cosmopolites spp., Curculio spp., Dermestes spp., Diabrotica spp., Epilachna spp., Eremnus spp., Leptinotarsa decemlineata, Lissorhoptrus spp., Melolontha spp., Orycaephilus spp., Otiorhynchus spp., Phlyctinus spp., Popillia spp., Psylliodes spp., Rhizopertha spp., Scarabeidae, Sitophilus spp., Sitotroga spp., Tenebrio spp., Tribolium spp. and Trogoderma spp.;
from the order Orthoptera, for example, Blatta spp., Blattella spp., Gryllotalpa spp., Leucophaea maderae, Locusta spp., Periplaneta spp. and Schistocerca spp.; from the order Isoptera, for example, Reticulitermes spp.; from the order Psocoptera, for example, Liposcelis spp.; from the order Anoplura, for example, Haematopinus spp., Linognathus spp., Pediculus spp., Pemphigus spp. and Phylloxera spp.; from the order Mallophaga, for example, Damalinea spp. and Trichodectes spp.; from the order Thysanoptera, for example, Frankliniella spp., Hercinothrips spp., Taeniothrips spp., Thrips palmi, Thrips tabaci and Scirtothrips aurantii; from the order Heteroptera, for example, Cimex spp., Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Triatoma spp.;
from the order Homoptera, for example, Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Paratoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; from the order Hymenoptera, for example, Acromynnex, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.; from the order Diptera, for example, Aedes spp., Antherigona soccata, Bibio hortulatzus, Calliphora erythroceplzala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp. and Tipula spp.; from the order Siphonaptera, for example, Ceratophyllus spp. and Xenopsylla cheopis and from the order Thysanura, for example, Lepisma saccharina.

Polymer coatings according to the invention having an nematicide may be used for the protection of the plant propagation material and developing plants against representatives of the class Nematoda including, for example: root knot nematodes, stem eelworms and foliar nematodes; especially Heterodera spp., for example Heterodera schachtii, Heterodora avenae and Heterodora trifolii; Hoplolaimus spp. such as Hoplolaimus galeatus and Hoplolaimus columbus; Globodera spp., for example Globodera rostochiezzsis; Meloidogyne spp., for example Meloidogyne incoginita and Meloidogyne javanica; Radopholus spp., for example Radopholus similis; Rotylenchulus spp. such as R. reniformis; Pratylenchus spp., for example Pratylenchus neglectans and Pratylenchus penetrans; Tylenchulus spp., for example Tylenchulus semipenetrans; Belonolaimus spp.; Longidorus spp.; Trichodorus spp.; Xiphinema spp.; Ditylenchus spp.; Aphelenchoides spp.; and Anguina spp.; in particular Meloidogyne spp., for example Meloidogyne incognita, and Heterodera spp., for example Heterodera glycines.

### Coating Formulation and Process

The thickness and structure of the polymer formed can vary according to the amount and the nature of the reactants. The thickness of the coating formed on the surface of the plant propagation material can vary between 0.001 to 10000 microns. Preferably, the thickness varies from between 0.01 to 1000 microns. More preferably, the thickness of the coating formed on the surface of the plant propagation material varies from between 0.1 to 1000 microns.

The process of the present invention may optionally contain variants such as varying the order of addition and the timing of introduction of the components, or adding a pH buffer or catalyst into the reaction. For example, any conventional condensation polymerization catalyst may be used to prepare the coating of this invention including triethylenediamine, dialkyltin compounds, such as dimethyltin oxide, dibutyltin oxide, dioctyltin oxide, etc.; distanoxanes, such as bis(dibutyltin acetate) oxide, bis(dibutyltin laurate) oxide etc.; and dialkyltin dicarboxylates, such as dibutyltin diacetate, dibutyltin dilaurate, and so forth.

Depending upon the particular plant propagation material to be coated, the conditions under which it is to be stored, and the soil and weather conditions under which it is expected to germinate and grow, the coating composition of the present invention may include a wide spectrum of one or more additives. Such additives include, but are not limited to, uv-protectants, pigments, dyes, extenders such as flour, dispersing agents, excipients, anti-freezing agents, preservatives, herbicidal safeners, fertilizers, biocontrol agents, surfactants, sequestering agents, plasticizers, colorants, brighteners, emulsifiers, flow agents such as calcium stearate, talc and vermiculite, coalescing agents, defoaming agents, humectants, thickeners, waxes, bactericides, insecticides, pesticides, and fillers such as cellulose, glass fibers, clay, kaolin, talc, calcium carbonate and wood meal, and odor-modifying agents. Typical excipients include finely divided mineral substances such as pumice, attapulgite, bentonite, kaoline zeolite, diatomite, and other clays, modified diatomaceous adsorbents, charcoal, vermiculite, finely divided organic substances such as peat moss, wood powder, and the like.

The concentration of the polymerizable reactant in the seed coating composition is from 1 to 50 weight percent, based on the total weight of the seed coating composition. Preferably the concentration of the polymerizable reactant in the seed coating composition is from 1 to 30 weight percent.

The seed coating composition is preferably distributed on the surface of the seed in a substantially uniform manner. Suitable means of applying the coating composition on plant propagation material is by various methods known to those skilled in the art. Three well known techniques include the use of drum coaters, rotating bowl or HEGE seed coater, and vortex or NIKLAS coaters. In one embodiment, seeds may be presized prior to coating.

A film overcoating can be optionally applied to the coated plant propagation material of the invention. The film overcoat may protect the coating layers, and/or allow for easy identification of the treated seeds or plant propagation materials, and/or function to increase the bulk or uniformity of the coating.

Various materials are suitable for overcoating including but not limited to, methyl cellulose, hydroxypropylmethylcellulose, dextrin, gums, waxes, vegetable or paraffin oils; water soluble or water disperse polysaccharides and their derivatives such as alginates, starch, and cellulose; and synthetic polymers such as polyethylene oxide, polyvinyl alcohol and polyvinylpyrrolidone and their copolymers and related polymers including mixtures of such polymers. The overcoat, if present, may optionally include any additives such as those previously mentioned.

### EXAMPLES

In order that those skilled in the art will be better able to practice the invention, the following examples are given by way of illustration and not by way of limitation. The registered trademarks and other designations denote the following products. The suppliers are known or may easily be found.

| | | |
|---|---|---|
| Abamectin 500FS | | |
| BU Color coat red | Seed pigment | Becker Underwood |
| BU purple dispersion | Seed pigment | Becker Underwood |
| BU seed gloss | Seed pigment | Becker Underwood |
| Cruiser ® 5FS | Thiamethoxam | Syngenta |
| Dynasty ™ 100FS | Azoxystrobin | Syngenta |
| Maxim ® XL | Fludioxonil | Syngenta |
| Rubinate ® M | MDI, 31.5% isocyanate | Huntsman |
| | concentration | |
| HMDA | Hexamethylene diamine | Fisher |
| | 70% solution in water | |
| Corn seed | e.g. hybrids N32-L9, | Various |
| | N79-L3, N43-L4, N67-T4, | |
| | DKC61-24 | |
| Cotton seed | e.g. hybrids; ST5599, | Stoneville, Delta |
| | ST4892, 572-E-1345-N2H | Pine |
| Antifoam 1500 | | Dow Corning |

### Examples A-D

### Conventional Pesticide Seed Treatment

Examples A-D illustrate the dressing of corn and cotton seed with conventional pesticide seed treatments. 500 g of seed are placed in the treater bowl of a Hege 11 seed treater. An aqueous pesticide slurry is then prepared by mixing pesticides, colour pigments, polymers, a neutralizer (if any), and water until a homogeneous phase is achieved. The Hege motor was turned on and the resulting slurry was applied on to the spinning disc of the seed treater into the bed of tumbling seed via syringe. Agitation is stopped when the seeds appear almost dried (can take up to 1 minute). Table 1 indicates the details of the seed treatment compositions used. The numbers given in the Table indicate component weight in grams per 500 g seed. All machine settings were according to the manufacturer's recommendations and within normal limits as would be understood by one having skill in the art of seed coating.

TABLE 1
Conventional Pesticide

| | A | B | C | D |
|---|---|---|---|---|
| Plant Seed - 500 g | Corn | Corn | Cotton | Cotton |

Pesticide Slurry Components

| | | | | |
|---|---|---|---|---|
| Abamectin 500FS | — | — | 1-1.5 | 1-1.5 |
| BU Color coat red | 0.121 | 0.121 | — | — |
| BU Purple dispersion | — | — | 0.2-0.4 | 0.2-0.4 |
| CF Clear Coat | — | 0.75-1.0 | — | — |
| Calcium carbonate | — | — | 2-3 | 2-3 |
| (neutralizer) | | | | |
| Cruiser 5FS | 0.575-5.75 | 0.575-5.75 | 2-3 | 2-3 |
| Dynasty 100FS | — | — | 1-2 | 1-2 |
| Maxim XL | 0.065 | 0.065 | — | — |
| Secure Polymer | — | | — | 0.2-0.4 |
| Water | 2-10 | 2-10 | 1-2 | 1-2 |

### Example 1

### Michael Addition

Example 1 illustrates the preparation of a polymer overcoat on pesticide treated corn and cotton seeds. The corn and cotton seeds were treated with pesticides in accordance with the procedures of examples A and C, respectively. The examples are performed by placing 500 g of pesticide treated corn or cotton seed, as the case may be, in the treater bowl of a Hege 11 liquid seed treater as explained above. Then, the polyethylenically unsaturated monomer, 3.00 g polyethylene glycol diacrylate (Mn=263), obtained from Sigma-Aldrich, Milwaukee, Wis., is injected on to the spinning disc of the seed treater. After the material has substantially coated the spinning seeds, rotation is temporarily halted so that the spinning disc may be wiped clean to prevent the reaction from taking place on the disc. Subsequently, a diamine, 3.79 g of 35 wt % hexamethylene diamine in water is injected on to the spinning disc of the seed treater. The reaction takes place in only a couple of seconds and results in a physically crosslinked matrix over coat surrounding each individual pesticide treated seed. Agitation is stopped when the seeds appear almost dried (can take up to 1 minute). All machine settings were according to the manufacturer's recommendations and within normal limits as would be understood by one having skill in the art of seed coating. When dust-off tests were conducted several days later, no dust-off was able to be measured.

Corn seeds treated with thiamethoxam as active ingredient and contacted with pure water were measured at varying intervals in the 24-hour period after treatment. Measuring the amount of thiamethoxam found in the water at each interval shows that only 60% of the thiamethoxam is released while in contact with water, and the residual 40% is slowly released over time. The results are provided in Tables 2 and 3.

TABLE 2

| | TMX | TMX | TMX | TMX | TMX | TMX | | TMX | TMX |
|---|---|---|---|---|---|---|---|---|---|
| | Found | Found | Found | Found | Found | Found | TMX | Found | Found |
| | (ppm) @ | (ppm) | (ppm) | (ppm) @ | (ppm) @ | (ppm) @ | Found | (ppm) | (ppm) @ |
| Code** | .25 hr. | @ .5 hrs. | @ 1 hr. | 1.5 hrs. | 2 hrs. | 4 hrs. | (ppm) @ 6 hrs. | @ 8 hrs. | 24 hrs. |
| 76696 | 3120 | 3560 | 4090 | 4390 | 4450 | 4720 | 4785 | 4943 | 5009 |
| 76697 | 3730 | 4160 | 4540 | 4760 | 4790 | 5010 | 4915 | 5021 | 5285 |
| 76698 | 3810 | 4060 | 4220 | 4340 | 4500 | 4380 | 4227 | 4146 | 4028 |
| 76699 | 3660 | 3920 | 3990 | 4250 | 4340 | 4320 | 4284 | 4219 | 4126 |
| 76700 | 4480 | 4570 | 4720 | 4880 | 4840 | 4730 | 4743 | 4864 | 5067 |
| 76701 | 4360 | 4500 | 4560 | 4640 | 4710 | 4680 | 4964 | 4860 | 4701 |

Sample Key:
LIMS 76996 - Corn t/w Cruiser, poly (BisA) #1, NB 1332-84
LIMS 76997 - Corn t/w Cruiser, poly (BisA) #2, NB 1332-85
LIMS 76998 - Corn t/w Cruiser, poly (PEGDA1) #1, NB 1332-86
LIMS 76999 - Corn t/w Cruiser, poly (PEGDA1) #2, NB 1332-87
LIMS 76700 - Corn t/w Cruiser, poly (PPGDA) #1, NB 1332-88
LIMS 76701 - Corn t/w Cruiser, poly (PPGDA) #2, NB 1332-89

TABLE 3

| | TMX | TMX | TMX | TMX | TMX | TMX | TMX | TMX | TMX |
|---|---|---|---|---|---|---|---|---|---|
| | Found | Found | Found | Found | Found | Found | Found | Found | Found |
| | (ppm) | (ppm) | (ppm) | (ppm) @ | (ppm) | (ppm) | (ppm) | (ppm) | (ppm) @ |
| Code** | @ .25 hr. | @ .5 hrs. | @ 1 hr. | 1.5 hrs. | @ 2 hrs. | @ 4 hrs. | @ 6 hrs. | @ 8 hrs. | 24 hrs. |
| 76702 | 3920 | 4160 | 4380 | 4500 | 4700 | 4420 | 5110 | 4440 | 4440 |
| 76703 | 4180 | 4370 | 4540 | 4940 | 4870 | 4870 | 4330 | 4350 | 5040 |
| 76704 | 2940 | 3150 | 3500 | 3870 | 3930 | 4130 | 4280 | 4340 | 4350 |
| 76705 | 3200 | 3610 | 4150 | 4500 | 4100 | 4380 | 4730 | 4770 | 4680 |
| 76706 | 2850 | 3200 | 3690 | 4170 | 4240 | 4300 | 4250 | 4178 | 4430 |
| 76707 | 3150 | 3630 | 4200 | 4330 | 4700 | 4790 | 4530 | 4670 | 4310 |

Sample Key:
LIMS 76702 - Corn t/w Cruiser, poly (PEGDA2)) #1, NB 1332-90
LIMS 76703 - Corn t/w Cruiser, poly (PEGDA2) #2, NB 1332-91
LIMS 76704 - Corn t/w Cruiser, poly (TMPTA) #1, NB 1332-92
LIMS 76704 - Corn t/w Cruiser, poly (TMPTA) #2, NB 1332-93
LIMS 76706 - Corn t/w Cruiser, poly (PEDA) #1, NB 1332-94
LIMS 76707 - Corn t/w Cruiser, poly (PEDA) #2, NB 1332-95

### Example 2

### UV-Curable

Example 2 illustrates the preparation of a polymer over coat on pesticide treated corn and cotton seeds. The corn and cotton seeds were treated with pesticides in accordance with the procedures of examples A and C, respectively. The examples are performed by placing 500 g of pesticide treated corn or cotton seed, as the case may be, in the treater bowl of a Hege 11 liquid seed treater as explained in previous examples. A formulation of UV-curable monomers is made by using 1.5 g aromatic urethane diacrylate (CN976), 4.5 g bisphenol A epoxy acrylate (CN104), 3.0 g tripropylene glycol diacrylate (TPGDA) as reactive diluent (SR306), and 0.4 g reactive amine coinitiator (CN386), 0.4 g benzophenone and 0.2 g oligo (2-hydroxy-2-methyl-1-4(1-methylvinyl)phenyl propanone and 2-hydroxy-2-methyl-1-phenyl-1-propanone (monomeric) (Sarcure™ SR1129) as initiating species, all materials available from Sartomer Company, Exton, Pa. Then, 5.8 g of the UV-curable formulation is injected on to the spinning disc of the seed treater. Once the formulation has spread evenly among the seeds, the treater is slowed down and a UV-lamp is introduced to expose the seeds. The reaction takes place in only a couple of seconds and results in a polymeric over coat surrounding each individual pesticide treated seed. Agitation is stopped when the seeds appear almost dried (can take up to 2-3 minutes). All machine settings were according to the manufacturer's recommendations and within normal limits as would be understood by one having skill in the art of seed coating. The seeds were found to be 70% germinated after 7 days in the incubator.

### Example 3

### Aminoplast

Using the Hege apparatus described in Examples 1-2, 250 grams of cotton seed is placed in the treater and it is turned on. A mixture of 2.7 grams of Cymel U-80 (urea formaldehyde resin prepolymer) and 0.3 grams of pentaerythritol tetrakis(3-mercaptopropianate) as a crosslinker is added to the seed by a syringe dropping the liquid onto the spinning disk. Next, 3g of an aqueous phase consisting of 0.15 g of sodium dialkylnapthalenesulfonate (Petro BAF) and 2.85 g of tap water acidified to pH 2.0 with sulphuric acid is added through a syringe. After allowing the seeds to mix for a short duration, they were then removed from the treater and spread out in a pan to dry in a 50° C. oven.

### Comparative Examples

The physical properties of seed treated in accordance with examples A-D are compared with the properties of seed treated in accordance with examples 1-3 of the present invention.

Dust-off procedure: 50 g of treated seed, once dry (at least 24 hrs after treatment), are tumbled in a close system under vacuum @50 rpm (standard dust-off equipment, known by all seed companies). There is an air flow which is maintained through the container, and which is filtered through a 5 micron sieve. After 5 minutes the amount of dust on the filter is weighted. As noted above, examples A-B and 1.1-3.1 relate to corn seed and examples C-D and 1.2-3.2 relate to cotton seed. The results are shown in Tables 4 and 5 below.

TABLE 4

| | Example | | | | |
|---|---|---|---|---|---|
| | A | B | 1.1 | 2.1 | 3.1 |
| Corn Seed | no | CF Clear | Michael | UV | Aminoplast |
| Dust off (mg) | polymer | Coat | reaction | curable | |
| | 3.3 | 2.0 | <1.0 | <1.0 | <1.0 |

TABLE 5

| | Example | | | | |
|---|---|---|---|---|---|
| | C | D | 1.2 | 2.2 | 3.2 |
| Cotton Seed | no | Secure | Michael | UV curable | Aminoplast |
| Dust off (mg) | polymer | Polymer | reaction | | |
| | 6.1 | 4.9 | <0.5 | <1.0 | <0.5 |

Warm Germination and Accelerated aging procedures: The warm-germination test was used to determine the maximum germination potential of untreated seeds and seeds that were subjected to treatment. The accelerated aging test estimates the carryover potential of a seed lot in warehouse storage.

Procedure—Warm Germination: A random sample of 100 corn and cotton seeds from each seed lot prepared in accordance with examples A-D and 1.1-3.2 (as well as 100 untreated seeds) were placed in the bottom of germination trays between moist paper towels of regular size. The trays were covered in a plastic bag to prevent drying and placed in diffuse light at 23-27 degrees C. in an incubator. A final count of germinated seeds was made after 7 days. Percent germination was determined as the average number of seeds which had germinated within the test period minus any abnormal seeds, divided by the total number of original seeds, times 100.

Accelerated aging test: corn seeds (at least 100) were exposed to high temperatures (40-45° C.) and high relative humidity (90-100%) for short periods of time (48-96 hrs) and then tested in a standard warm germination test as described above. The results of warm germination and accelerated aging tests are shown in Tables 6-8 below.

### Warm Germination and Accelerated Aging Data:

TABLE 6

| | Example | | | | | |
|---|---|---|---|---|---|---|
| | — | A | B | 1.1 | 2.1 | 3.1 |
| Corn Seed | Untreated | no | CF | Michael | UV | Aminoplast |
| Warm | | polymer | Clear | reaction | curable | |
| Germ. % | | | Coat | | | |
| | 100 | 100 | 100 | 100 | 100 | Not tested |

TABLE 7

| | Example | | | | | |
|---|---|---|---|---|---|---|
| | — | C | D | 1.2 | 2.2 | 3.2 |
| Cotton | Un- | no | Secure | Michael | UV | Aminoplast |
| Seed | treated | polymer | Polymer | reaction | curable | |
| Warm | 80 | 80 | 70 | 80 | 80 | 65 |
| Germ. % | | | | | | |

TABLE 8

| | Example | | |
|---|---|---|---|
| | — | A | B |
| Corn Seed | Untreated | no polymer | CF Clear Coat |
| After Accel. | 90 | 90 | 100 |
| Aging, warm | | | |
| germ. % | | | |

The foregoing data demonstrate that seeds treated in accordance with the invention (examples 1-3) are much better than the seeds treated with the comparative compositions A-D with regard to dust-off, and without any substantial affect on germination potential or carryover as highlighted by the warm germination and accelerated aging test data.

In summary, it is seen that this invention provides a new polymer coating for the protection of plant propagation materials. Variations may be made in proportions, procedures and materials without departing from the scope of the invention as defined by the following claims.

1. A process for coating plant propagation material comprising contacting the plant propagation material with a coat-forming composition comprising at least one reactant having reactive functionality and a photoinitiator and curing the composition under ultraviolet conditions to form a coating on the surface of the plant propagation material.

2. The process according to claim 1, wherein the reactant is selected from (a) a monomer or oligomer containing a monoethylenically and/or polyethylenically unsaturated functionality and/or (b) an epoxy functionalized monomer or oligomer containing one or more epoxy groups available for reaction.

3. The process according to claim 2 wherein the photoinitiator is present in an amount from 0.001% to about 15% by weight based on the solids content of the composition.

4. The process according to claim 3, wherein the photoinitiator is selected from benzophenone, 4-phenylbenzophenone and 4-chlorobenzophenone, Michler's ketone, 1-benzoylcyclohexan-1-ol, 2-hydroxy-2,2-dimethylacetophenone, and 2,2-dimethoxy-2-phenylacetophenone methyl, ethyl and butylbenzoin ethers benzyl dimethyl ketal, 2-methyl-1-[4-(methylthio)phenyl]-2-morpholinopropan-1-one, anthraquinone, methylanthraquinone, tert-butylanthraquinone, 2,4,6-trimethylbenzoyldiphenylphosphine oxide, ethyl 2,4,6-trimethylbenzoylphenylphosphinate, methyl 2,4,6-trimethylbenzoylphenylphosphinate and bisacylphosphine oxides.

5. (canceled)

6. The process according to claim 4, wherein the reactant is selected from ethoxylated bisphenol A di(meth)acrylate, divinylbenzene, vinyl(meth)acrylate, allyl(meth)acrylate, diallyl maleate, diallyl fumarate, methylene bisacrylamide, cyclopentadienyl acrylate, triallyl cyanurate, poly(ethylene glycol) di(meth)acrylate, ethylene glycol di(meth)acrylate, diethylene glycol di(meth)acrylate, 1,3-butylene glycol di(meth)acrylate, 1,4-butylene glycol di(meth)acrylate, neopentyl glycol di(meth)acrylate, and propylene glycol di(meth)acrylate.

7. The process according to claim 4, wherein the reactant is an epoxy functionalised monomer.

8. The process according to claim 7, wherein the epoxy functionalised monomer has a functionality of at least two and wherein the epoxy functionalised monomer is present in amounts up to about 80 weight %.

9. (canceled)

10. The process according to claim 8, wherein the epoxy functionalised monomer is selected from phenols, novolacs, linear and cycloaliphatic polyols, polyether polyols and siloxanes.

11. The process according to claim 10, wherein the epoxy functionalised monomer is selected from bisphenol A diglycidyl ethers, glycidyl(meth)acrylate, epoxy(meth)acrylate, epoxy novolacs, epoxy cresols, and cycloaliphatic epoxides.

12. The process according to claim 4, wherein the curing occurs at a wavelength between 190-400.

13. The process according to claim 12, wherein the curing occurs at a wavelength between 240-370.

14. The process according to claim 4, wherein the coat-forming composition further comprises one or more UV-stabilizers, thickeners, levelling assistants, defoamers, lubricants, and fillers.

15. A process for coating plant propagation material comprising contacting the plant propagation material with a coat-forming composition comprising a substantially equimolar amount of at least one polyfunctional amine and at least one polyfunctional ethylenically unsaturated monomer to form a coating on the surface of the plant propagation material.

16. The process according to claim 15, wherein the at least one polyfunctional amine is selected from ethylenediamine, propylenediamine, trimethylene diamine, tetramethylene diamine, pentamethylene diamine, hexamethylene diamine, 4-(aminomethyl)-1,8-octanediamine, decamethylene diamine, 1,2-diaminocyclohexane, isophoronediamine, tris(2-aminoethyl)amine, diethylenetriamine, dipropylenetriamine, dibutylenetriamine, triethylene tetramine, triaminopropane, 2,2,4-trimethylhexamethylene diamine, tolylene diamine, hydrazine, piperadine, isophorone diamine, dicyclohexylmethane-4,4′-diamine, phenylene diamine and xylylene diamine.

17. The process according to claim 15, wherein the at least one polyfunctional ethylenically unsaturated monomer is selected from alkylene glycol diacrylates and dimethacrylates, divinylbenzene, vinyl(meth)acrylate, allyl(meth)acrylate, diallyl maleate, diallyl fumarate, methylenebisacrylamide, cyclopentadienyl acrylate, triallyl cyanurate, and poly(ethylene glycol)di(meth)acrylate.

18. The process according to claim 17, wherein the alkylene glycol diacrylates and dimethacrylates are selected from ethylene glycol di(meth)acrylate, diethylene glycol di(meth)acrylate, 1,3-butylene glycol di(meth)acrylate, 1,4-butylene glycol di(meth)acrylate, neopentyl glycol di(meth)acrylate, ethoxylated bisphenol A di(meth)acrylate, and propylene glycol di(meth)acrylate.

19. The process according to claim 15, wherein the polyfunctional amine and the polyfunctional ethylenically unsaturated monomer may independently be provided neat or may be in aqueous form.

20. (canceled)

21. (canceled)

22. A process for coating plant propagation material comprising contacting the plant propagation material with a coat-forming composition comprising an amino resin prepolymer with an acidic aqueous phase containing a catalyst to form a coating on the surface of the plant propagation material.

23. The process according to claim 22, wherein the composition is at a temperature between 25° C. and 60° C.

24. The process according to claim 23, wherein the composition is at a temperature between 40° C. and 50° C.

25. The process according to claim 24, wherein the amino resin prepolymer is selected from urea-formaldehyde, melamine-formaldehyde, benzoguanamine-formaldehyde, and glycoluril-formaldehyde.

26. The process according to claim 25, wherein the urea-formaldehyde is selected from Cymel U-80 and Cymel U-1050-10 resins.

27. The process according to claim 24, wherein the acid aqueous phase is prepared with and acid selected from sulphonic acid, hydrochloric acid, phosphoric acid, formic acid, and citric acid.

28. (canceled)

29. The process according to claim 26, further comprising a crosslinking agent.

30. The process according to claim 29, wherein the crosslinking agent is selected from polyfunctional mercaptan esters and pentaerythritol tetrakis(3-mercaptoproprionate).

31. (canceled)

32. The process according to claim 25, wherein the amino resin prepolymer is melamine-formaldehyde.

33. The process according to claim 25, wherein the amino resin prepolymer is benzoguanamine-formaldehyde.

34. The process according to claim 25, wherein the amino resin prepolymer is glycoluril-formaldehyde.

35. The process according to claim 25, wherein the catalyst is selected from carboxylic acids, sulphonic acids, and metal salts thereof.

36. The process according to claim 32, further comprising a crosslinking agent, wherein the crosslinking agent is pentaerythritol tetrakis(3-mercaptoproprionate), the catalyst is sulphonic acid, and the composition is at a temperature between 40° C. and 50° C.

37. The process according claim 1, wherein the coat-forming composition further comprises at least one active ingredient.

38. The process according to claim 15, wherein the coat-forming composition further comprises at least one active ingredient.

39. The process according to claim 22, wherein the coat-forming composition further comprises at least one active ingredient.

40. (canceled)

41. (canceled)

42. (canceled)

43. The process according to claim 1, wherein the coat-forming composition further comprises at least one active ingredient and wherein the plant propagation material is pre-treated with at least one active ingredient which is the same or different.

44. The process according to claim 15, wherein the coat-forming composition further comprises at least one active ingredient and wherein the plant propagation material is pre-treated with at least one active ingredient which is the same or different.

45. The process according to claim 22, wherein the coat-forming composition further comprises at least one active ingredient and wherein the plant propagation material is pre-treated with at least one active ingredient which is the same or different.

46. The process according to claim 43, wherein the active ingredient is selected from abamectin, acephate, acetamiprid, alpha-cypermethrin, azinphos-methyl, bifenthrin, carbaryl, carbofuran, carbosulfan, chlorpyrifos, clothianidin, cyromazine, deltamethrin, dimethoate, emamectin benzoate, endosulfan, fipronil, furathiocarb, gamma-HCH, imidacloprid, Isofenphos, methiocarb, omethoate, tefluthrin, thiamethoxam, thiacloprid, thiodicarb, azoxystrobin, pyraclostrobin, benomyl, bitertanol, captan, carbendazim, carboxin, chlorothalonil, copper salts, cymoxanil, cyproconazole, cyprodinil, difenoconazole, diniconazole, ethirimol, famoxadone, fenamidone, fenhexamid, fenpiclonil, fluazinam, fludioxonil, fluquinconazole, flutolanil, flutriafol, fosetyl-aluminium, fuberidazole, guazatine, hexaconazole, hymexazol, imazalil, iprodione, isofenphos, mancozeb, maneb, metalaxyl, metalaxyl-M, metconazole, myclobutanil, silthiofam, nuarimol, oxadixyl, oxine-copper, oxolinic acid, pencycuron, prochloraz, procymidone, pyrimethanil, pyroquilon, quintozene, tebuconazole, tetraconazole, thiabendazole, thiophanate-methyl, thiram, triadimenol, triazoxide, triticonazole, trifloxystrobin, picoxystrobin and ipconazole.

47. The process according to claim 46, wherein the active ingredient is selected from the group consisting of thiamethoxam, imidacloprid, profenofos, fludioxonil, difenoconazol, abamectin, mefenoxam, teflutrin, and azoxystrobin.

48. (canceled)

49. (canceled)

50. The process according to claim 1, wherein the propagation material is selected from seeds, roots, fruits, tubers, bulbs, rhizomes, and plant cuttings.

51. The process according to claim 50, wherein the plant propagation material is seed.

52. The process according to claim 51 wherein the seed is selected from beet, canola, rape, mustard seed, poppy, olives, sunflowers, coconut, castor oil plants, cocoa beans, groundnuts, soya, peanuts, wheat sorghum, cotton, corn, tomatoes, soybeans, tobacco, tomatoes, cole, cabbages, onions, carrots, and ornamental flowers.

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)
